(19) United States
(12) Patent Application Publication
(10) Pub. No.: US 2009/0273282 A1
(43) Pub. Date: Nov. 5, 2009

(54) CONFIGURABLE TAIL LIGHT MODULE

(76) Inventors: CLAUDIO R. BALLARD, HUNTINGTON, NY (US); GARY FULKERSON, WHITE LAKE, MI (US); JEFF SEWARD, FAIRFAX, VT (US)

Correspondence Address: HOWISON & ARNOTT, L.L.P, P.O. BOX 741715, DALLAS, TX, 75374-1715, US

(21) Appl. No.: 12/395,367

(22) Filed: Feb. 27, 2009

Related U.S. Application Data
(60) Provisional application No. 61/034,693, filed on Mar. 7, 2008.

(51) Int. Cl. B60Q 1/30; H05B 37/02

(52) U.S. Cl. 315/77; 315/294

(57) ABSTRACT

The present disclosure provides a tail light module comprising a configurable indicator array that includes a plurality of individually controllable lights that may be activated and deactivated to form a plurality of light patterns.

### CROSS-REFERENCE TO RELATED APPLICATIONS

This application claims the benefit of U.S. Provisional Application for Patent Serial No. 61/034,693, filed Mar. 7, 2008, and entitled CONFIGURABLE TAIL LIGHT MODULE, the specification of which is incorporated herein in its entirety by reference.

### TECHNICAL FIELD

The following disclosure relates to vehicle lighting and, more particularly, to a configurable tail light module.

### BACKGROUND

It is well known to use one or more tail lights to indicate various maneuvers that are to be performed or are being performed by a vehicle, such as braking or signaling a left or right turn. However, tail lights are typically special purpose lights that are designed to perform a fixed lighting function. Therefore, a need exists for a vehicle tail light solution that provides flexibility.

### SUMMARY

In one embodiment, the present disclosure provides a tail light module comprising a support structure, a configurable indicator array, and at least one controller. The support structure has a cavity formed therein and the cavity contains at least part of a frame spanned by a plurality of cross-members. The configurable indicator array is positioned adjacent to the plurality of cross-members and includes a plurality of individually controllable lights. The controller is coupled to the configurable indicator array, and is configured to activate and deactivate at least some of the plurality of individually controllable lights to simultaneously form at least two light patterns on the configurable indicator array. The two light patterns are selected from a plurality of possible light patterns.

In another embodiment, the present disclosure provides a tail light system comprising a support structure, a bezel, a light array, and at least one controller. The support structure is configured to be attached to a vehicle and includes a cavity. The bezel is coupled to the support structure and positioned at least partially within the cavity. The bezel has a frame and a plurality of cross-members coupled to the frame. The cross-members are separated from one another by a space. The light array is positioned at least partially within the cavity. The light array has a plurality of individually controllable lights positioned to emit light through the spaces separating the cross-members. The at least one controller is coupled to the light array. The controller is configured to activate and deactivate first and second portions of the plurality of individually controllable lights to form first and second light patterns, respectively, on the light array. The first and second light patterns can be formed simultaneously.

In yet another embodiment, the present disclosure provides a tail light module comprising a bezel, a light emitting diode (LED) array, and a controller. The bezel has a frame and a plurality of substantially planar cross-members coupled to the frame. The cross-members are substantially parallel to one another with a space between each cross-member and the adjacent cross-members. The LED array has a plurality of individually controllable LEDs. The LED array is positioned relative to the cross-members so that the plurality of individually controllable LEDs can emit light through the spaces existing between the cross-members. The controller is coupled to the LED array. The controller is configured to activate and deactivate a first set of the plurality of individually controllable LEDs to form a brake light pattern and a second set of the plurality of individually controllable LEDs to form a turn signal pattern. The brake light and turn signal patterns can be activated simultaneously.

### BRIEF DESCRIPTION OF THE DRAWINGS

For a more complete understanding, reference is now made to the following description taken in conjunction with the accompanying Drawings in which:

FIG. 1 illustrates a solid model perspective view of a tail light module in accordance with one embodiment of the present disclosure;

FIG. 2 illustrates a solid model perspective view of one embodiment of a tub that may be used in the tail light module of FIG. 1;

FIGS. 3a and 3b illustrate solid model and wireframe perspective top views, respectively, of one embodiment of a bezel that may be used in the tail light module of FIG. 1;

FIGS. 4a and 4b illustrate solid model and wireframe perspective bottom side views, respectively, of the bezel of FIGS. 3a and 3b;

FIGS. 4c and 4d illustrate solid model and wireframe perspective rear views, respectively, of the bezel of FIGS. 3a and 3b;

FIGS. 5a and 5b illustrate solid model and wireframe cross-sectional perspective views, respectively, of the tail light module of FIG. 1;

FIGS. 6a-6d illustrate embodiments of a configurable indicator array that may be used in the tail light module of FIG. 1, wherein:

FIG. 6a is a top view of one embodiment;

FIG. 6b is a perspective view of one embodiment;

FIG. 6c is a side view of one embodiment; and

FIG. 6d is a side view of another embodiment;

FIG. 7 illustrates a diagrammatic view of one embodiment of a system that may be used in conjunction with various components of the tail light module of FIG. 1;

FIG. 8 illustrates a diagrammatic view of one embodiment of an arrangement of lighting and control components in two tail light modules, each of which may be similar or identical to the tail light module of FIG. 1; and

FIGS. 9a and 9b illustrate side and back views of one embodiment of a vehicle with the tail light module of FIG. 1.

### DETAILED DESCRIPTION

Referring now to the drawings, wherein like reference numbers are used herein to designate like elements throughout, the various views and embodiments of a configurable tail light module. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

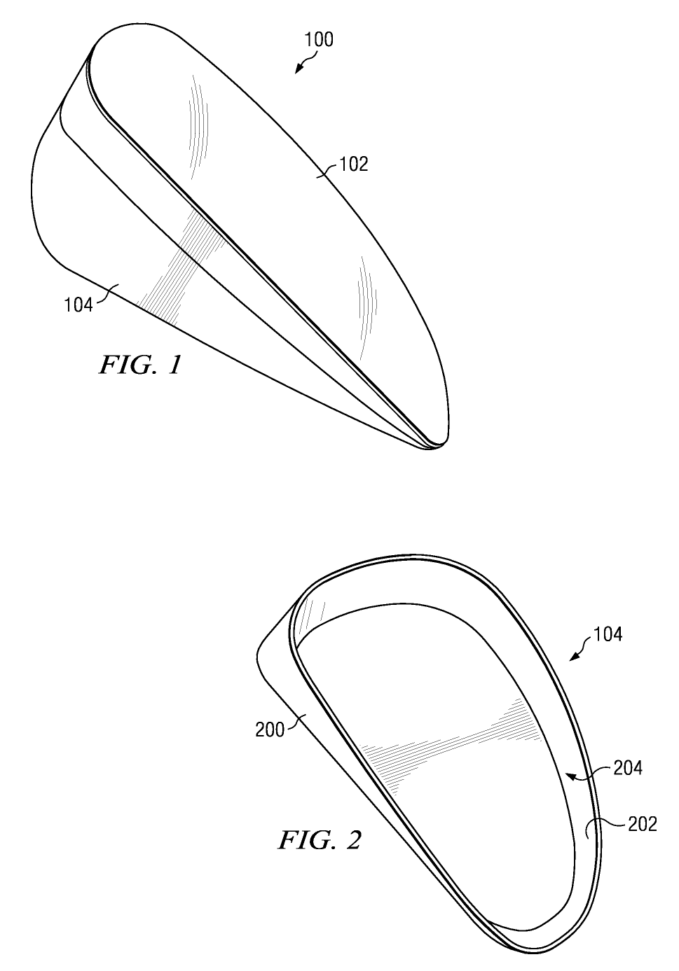

Referring to FIG. 1, one embodiment of a tail light module 100 is illustrated. The tail light module 100 includes a transparent/translucent cover 102 and a tub 104, which may be transparent, translucent, or opaque. The tail light module 100 may be designed to fit at least partially into a cavity in a vehicle.

The cover 102 may be curved outwardly (i.e., an exterior surface of the cover 102 may be convex) and may have a relatively uniform thickness. It is understood that the curvature, thickness, transparency/translucency, and other properties of the cover 102 may vary and that such properties may be different in different areas of the cover. In the present example, the cover 102 may be translucent with an upper red portion and a lower white portion. Some or all of an exterior surface of the cover 102 may be reflective with respect to external light. For example, all or a portion of the exterior surface of the cover 102 may have a reflective coating or may have reflective structures integrated therein. Furthermore, while the cover 102 is illustrated as being a single piece of material in the present example, it is understood that it may be composed of multiple pieces.

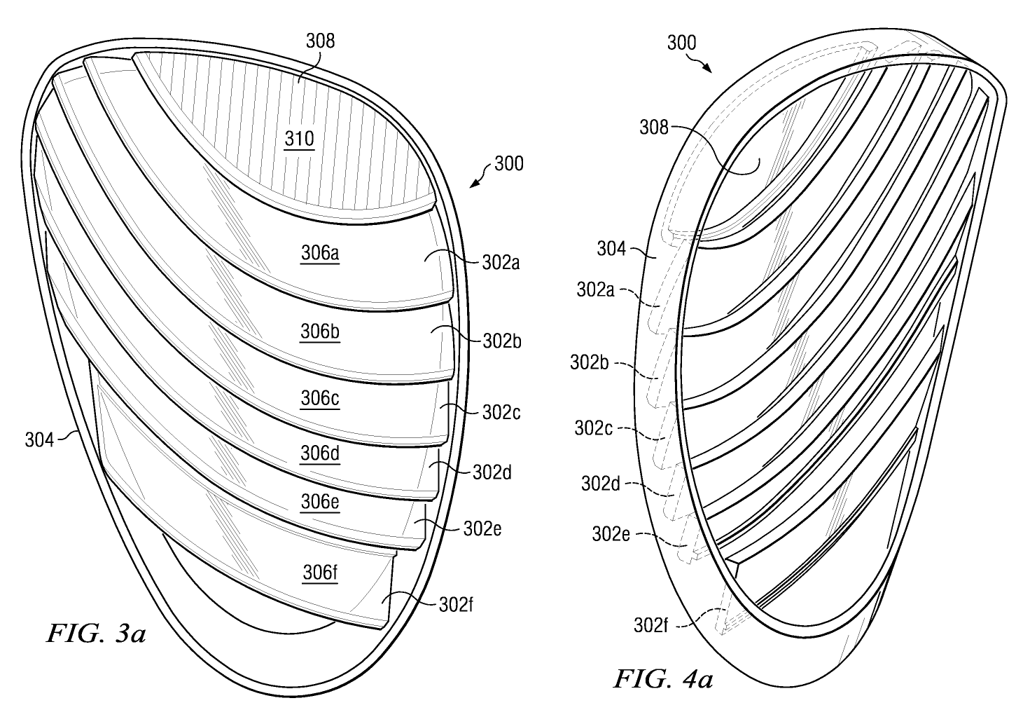

With additional reference to FIG. 2, one embodiment of the tub 104 of FIG. 1 is illustrated with an exterior surface 200 and an interior surface 202 defining a cavity 204. The cavity 204 may be identical in size or smaller than the cover 102 so that the cavity 204 is protected by the cover when the cover is in place. The tub 104 may include one or more coupling points or mounting features (not shown) that may be used to attach the tub to a vehicle. It is understood that the curvature, thickness, and other properties of the tub 104 may vary and that such properties may be different in different areas of the tub.

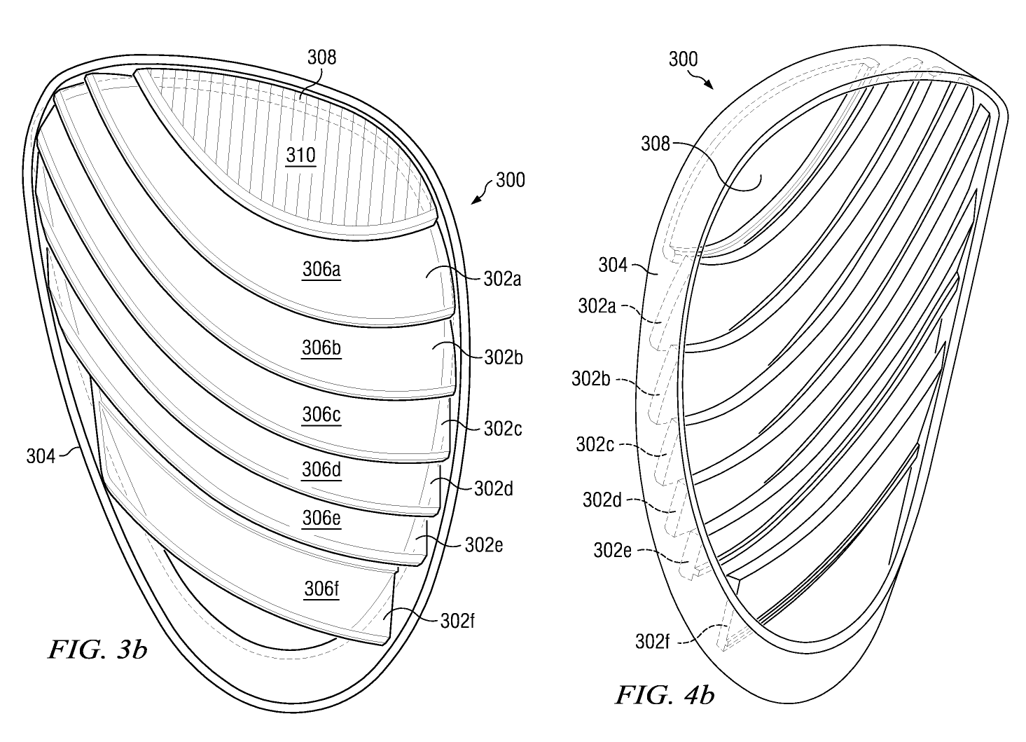

Referring to FIGS. 3a and 3b, one embodiment of a bezel 300 that may be used in the tail light module 100 of FIG. 1 is illustrated in solid model and wireframe perspective top views, respectively. The bezel 300 may be sized to fit at least partially within the cavity 204 of the tub 104 and provides support for one or more configurable indicator arrays, as will be described later in greater detail. In the present example, the bezel 300 includes a plurality of curved cross-members 302a-302f that span a frame 304. The cross-members 302a-302f have upper faces 306a-306f, respectively, that are adjacent to the interior side of the cover 102 and substantially parallel to the upper faces of the other cross-members. An additional member 308 having an upper face 310 may be fixed to an interior edge of the frame 304. The bezel 300 may include one or more coupling points or mounting features (not shown) that may be used to attach the bezel to the tub 104 or to another portion of a vehicle. It is understood that the curvature, thickness, cross-member dimensions, and other properties of the bezel 300 may vary and that such properties may be different in different areas of the bezel.

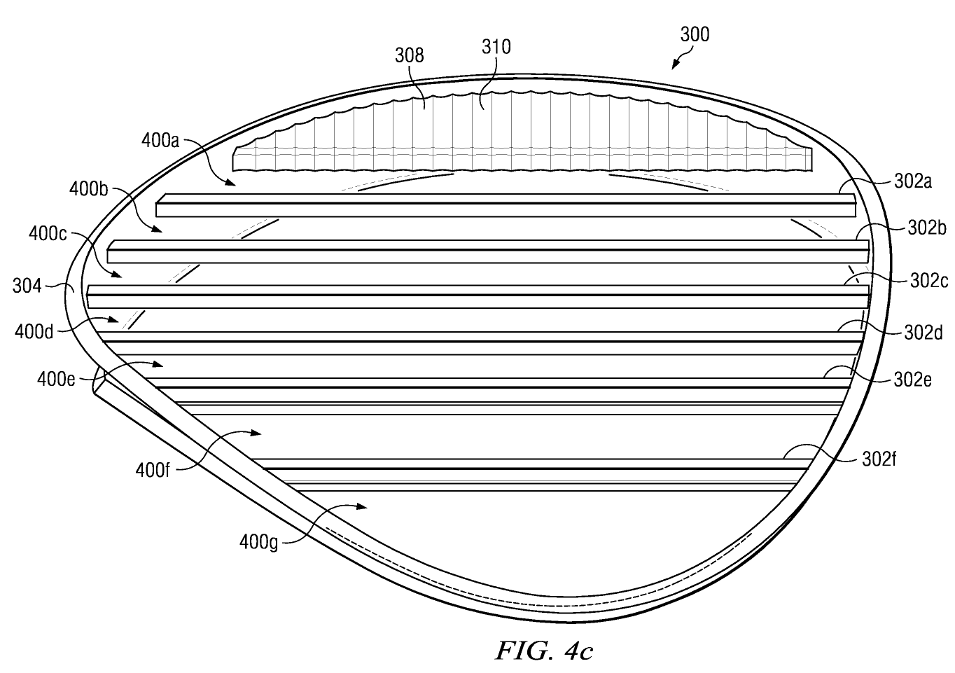

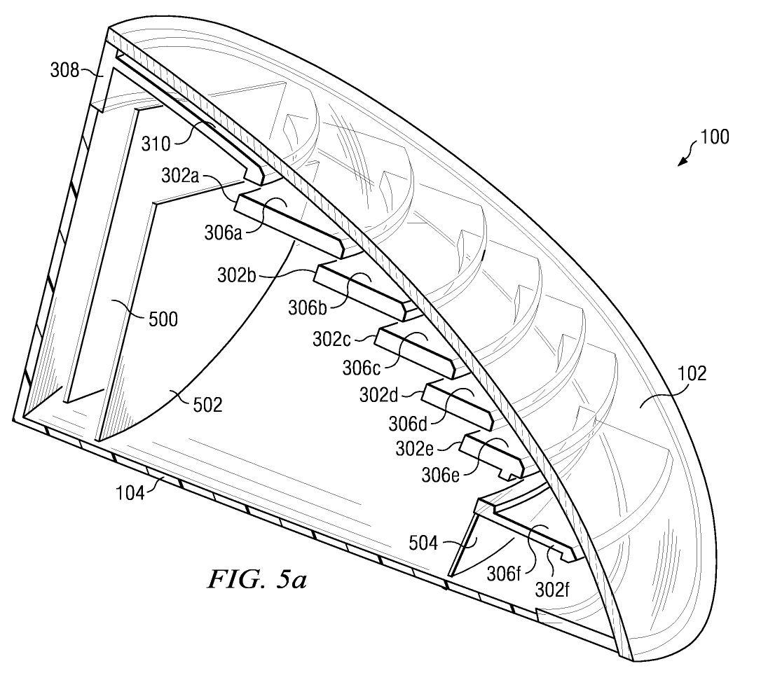

With additional reference to FIGS. 4a and 4b, the bezel 300 of FIGS. 3a and 3b is illustrated in solid model and wireframe perspective bottom side views, respectively. A configurable indicator array (described below with respect to FIGS. 6a-6d) that includes multiple lights that are controllable via a computer may be retained/supported by the cross-members 302a-302f.

With additional reference to FIGS. 4c and 4d, the bezel 300 of FIGS. 3a and 3b is illustrated in solid model and wireframe perspective rear views, respectively. The orientation of the bezel 300 in FIGS. 4c and 4d is approximately the orientation that would be visible to a viewer positioned behind an automobile in which the tail light module 100 is installed. As can be seen in FIGS. 4c and 4d, spaces 400a-400g exist between various cross-members 302a-302f. More specifically, space 400a exists between member 308 and cross-member 302a, space 400b exists between cross-members 302a and 302b, space 400c exists between cross-members 302b and 302c, space 400d exists between cross-members 302c and 302d, space 400e exists between cross-members 302d and 302e, space 400f exists between cross-members 302e and 302f, and space 400g exists between cross-member 302f and frame 304.

In some embodiments, one or more configurable indicator arrays may be placed in the spaces 400a-400g. For example, an array may have edges that slide into grooves in the cross-members 302a-302f. In other embodiments, one or more configurable indicator arrays may be placed behind (from the perspective of FIGS. 4c and 4d) the cross-members 302a-302f in such a way that light from the arrays passes through the spaces 400a-400g. For example, an array may clip or otherwise fasten to one or more of the cross-members 302a-302f. In still other embodiments, one or more configurable indicator arrays may be placed in front of (from the perspective of FIGS. 4c and 4d) the cross-members 302a-302f and the spaces 400a-400g may provide ventilation and electrical access to the arrays. In the present embodiment, the configurable indicator arrays are oriented to project light towards the viewer (e.g., perpendicular to the viewing surface formed by the drawings of FIGS. 4c and 4d), but it is understood that they may be oriented in many different directions.

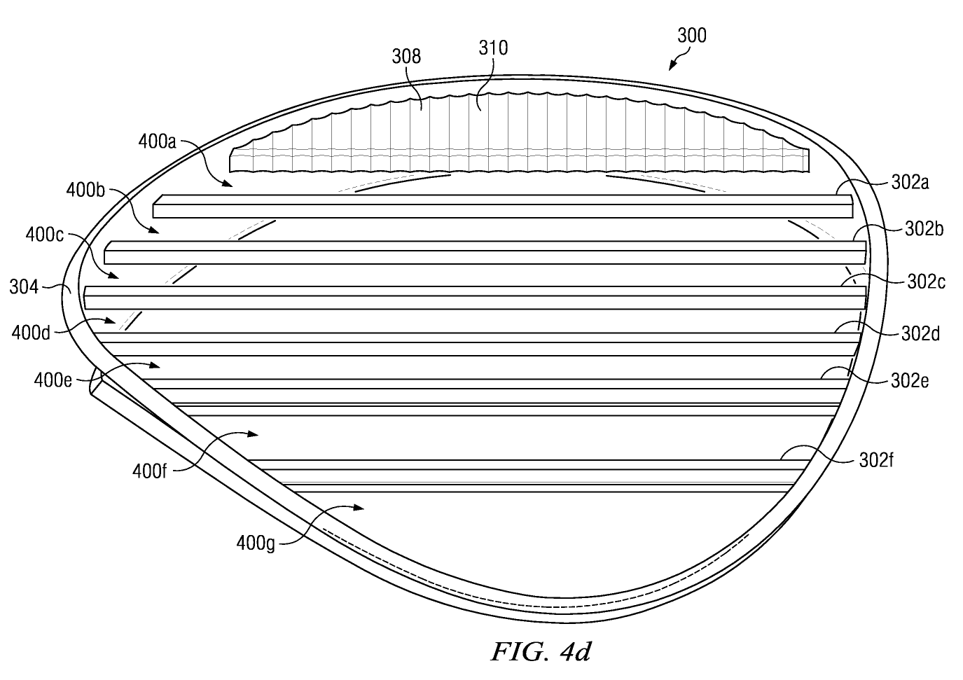

Referring to FIGS. 5a and 5b, one embodiment of the tail light module 100 of FIG. 1 is illustrated in solid model and wireframe cross-sectional perspective views, respectively. As can be seen, cross-members 302a-302f are positioned near the interior side of cover 102 in a tiered fashion with the upper faces of the cross-members being substantially parallel. Member 304 is also positioned near the interior side of cover 102. Three supports 500, 502, and 504 are illustrated in a substantially perpendicular orientation relative to the upper faces of the cross-members 302a-302f. The supports 500, 502, and 504 may be used to secure controllers (e.g., circuit boards) coupled to the configurable indicator array. In an alternative embodiment, the supports 500, 502, and 504 may be the controllers themselves. For example, the controllers may be relatively stiff circuit boards that may slide into grooves (not shown) or be otherwise attached to the bezel 300 and/or tub 104.

Referring to FIGS. 6a-6d, one embodiment of a configurable indicator array 600 may include multiple lights 602. For purposes of convenience, the disclosure will refer to the configurable indicator array 600 as using LEDs, but it is understood that any type of light source may be used. Although shown as a single array, it is understood that the configurable indicator array 600 may include multiple arrays. The LEDs 602 may be individually controllable and packaged in such a manner as to be capable of being affixed to or positioned alongside the cross-members 302a-302f while being oriented towards the interior surface of the cover 102. As described previously, the LEDs 602 may be positioned relative to the cross-members 302a-302f in many different ways. For example, the LEDs 602 may be packaged to slide over or otherwise wrap around the cross-members 302a-302f. In other embodiments, the cross-members 302a-302f may provide a frame having a hollow interior and an opening facing the interior surface of the cover 102, and the LEDs may be packaged for positioning within the cross-members.

The LEDs in the configurable indicator array 600 may be arranged in various M×N relationships, where M and N are greater than or equal to one (although gaps in the array may exist where no LED is present). Different LEDs may emit different wavelengths of light, and so the configurable indicator array 600 may emit light of a single color or of different colors. The LEDs may be packaged individually or may be packaged in groups, such as in a tri-color red-green-blue (RGB) LED package. Furthermore, the arrangement of the LEDs in the configurable indicator array 600 may vary, and the array itself may be arranged in various configurations (e.g., straight or curved). For example, FIG. 6a illustrates a rectangular 3×N LED array 600, where N=17. The values of M and N may be selected so as to fit within the designated space in the tail light module 100. In another example, FIG. 6b illustrates a curved 3×N LED array 600.

It is understood that the configurable indicator array 600 may include an exterior surface 604 (FIG. 6b) that provides support to the array but, in some embodiments, may also be somewhat flexible to allow the array to be positioned relative to the cross-members 302a-302f. In other embodiments, the exterior surface 604 may be relatively rigid and may be formed to fit within the tail light module 102 without altering the shape of the array.

As illustrated in FIGS. 6c and 6d, the configurable indicator array 600 may include a controller 606, which may be a circuit board or other device providing controllable power to the LEDs 602. In some embodiments, the controller 606 may receive a signal from a computer or other controller (not shown) with a relatively simple instruction (e.g., left turn) and the controller may manipulate the corresponding LEDs 602 to comply with the instruction without further input from the computer. Furthermore, the controller 606 may store multiple patterns representing different configurations of active/inactive LEDs, and multiple patterns may be executed simultaneously. In other embodiments, the controller 606 may receive detailed instructions from the computer identifying a pattern or specific LEDs 602 that are to be activated or deactivated. Other information, such as duration, may be received from the computer.

The controller 606 may be positioned immediately adjacent to the LEDs 602 (FIG. 6c) or may be separated from the LEDs (FIG. 6d). Furthermore, the controller 606 may be separated entirely from the configurable indicator array 600 and may be positioned elsewhere. In some embodiments, the controller 606 may include multiple circuit boards or other devices. Alternatively, a single controller 606 may control multiple configurable indicator arrays.

The configurable indicator array 600 provides flexibility to the tail light module 100. As the LEDs 602 in the configurable indicator array 600 may be activated/deactivated as desired, many combinations of lights are possible. For example, if a turn signal is desired, all LEDs in the configurable indicator array 600 may be activated in a blinking manner. Alternatively, only certain LEDs may be activated. In other examples, all or a portion of the LEDs 602 may be used as brake lights, hazard lights, and for other purposes. Furthermore, as different LEDs of the configurable indicator array 600 may be controlled individually, multiple functions may be executed simultaneously. For example, a portion of the LEDs may be used for brake lights, while another portion may be used as a turn signal when needed. In other embodiments, such as where the cover 102 is transparent or composed of a clear translucent material rather than a colored translucent material, different colors of LEDs may be used for different functions (e.g., yellow LEDs for turn signals and red LEDs for brake lights).

In embodiments where the configurable indicator array 600 provides sufficient resolution (i.e., where M×N are large enough), the configurable indicator array may provide additional functionality. For example, if M×N are sufficiently large, the LEDs may be activated in a pattern representative of an arrow to indicate a turn signal.

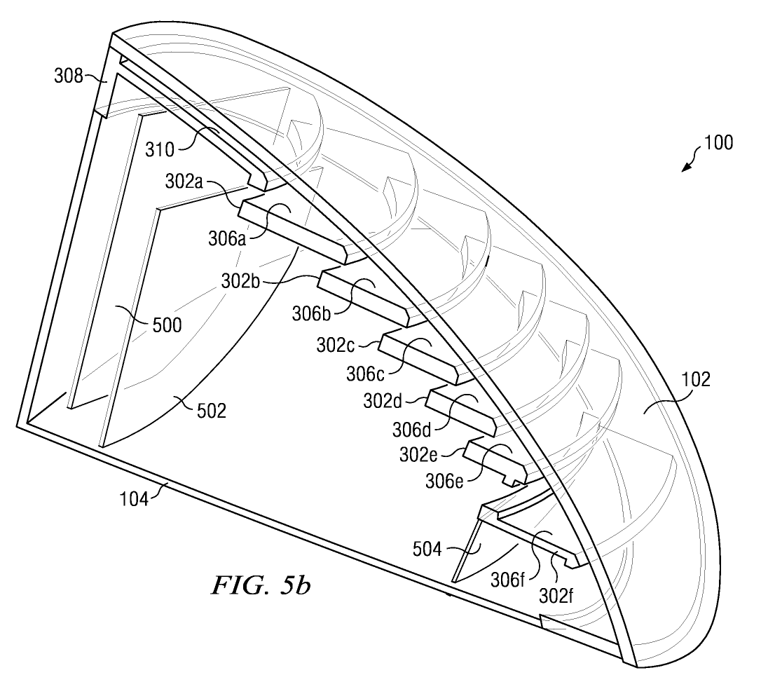

Referring to FIG. 7, one embodiment of a system 700 that may be used to control all or part of the tail light module 100 of FIG. 1 illustrates a computer 702 coupled to the configurable indicator array 600 of FIG. 6c. In the present example, the computer 702 is coupled to the controller 606, which then activates and deactivates the LEDs 602. In other embodiments, the computer 702 may control the LEDs 602 directly. It is understood that the computer 702 is representative of any control device that may send control signals to the configurable indicator array 600. Accordingly, while the computer 700 is illustrated with a central processing unit (CPU) 704, memory 706, and communication interface 708 (which may be wired or wireless) coupled by one or more control lines 710 (e.g., a bus), it is understood that many different control systems may be used with the configurable indicator array 600 and that various components may be distributed. Furthermore, one or more control lines 712 coupling the computer 702 to the configurable indicator array 600 may be wired as shown or may be wireless.

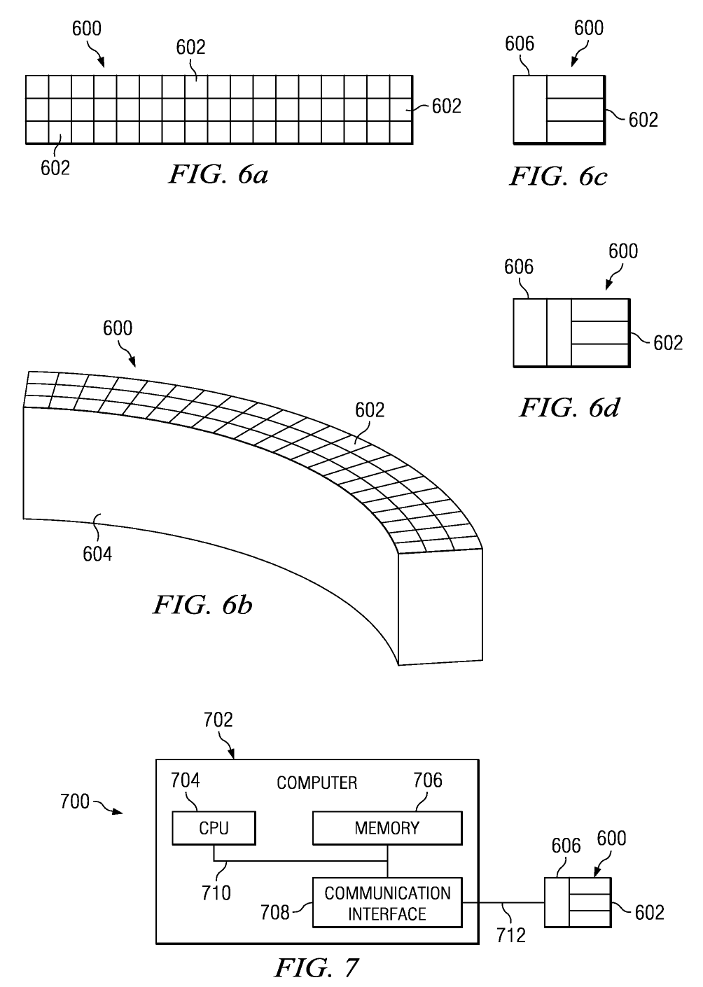

Referring to FIG. 8, one embodiment of an arrangement of lighting and control components in two tail light modules is illustrated in diagrammatic view. For example, the right column of components may represent the tail light module 100 that may be on the back right corner of a vehicle, while the left column of components may represent another tail light module 800 that may be on the back left corner of the vehicle. The tail light module 800 may be a mirror image of the tail light module 100. One or more configurable indicator arrays 600 in each of the tail light modules 100 and 800 may be arranged as illustrated with upper, middle, and lower portions each having an LED area and a controller area. For example, the upper and middle portions may function as brake and turn indicators, while the lower portion may function as a reverse indicator. It is understood that the functions shown may be arranged in many different ways and may have different numbers of LED areas and/or control areas.

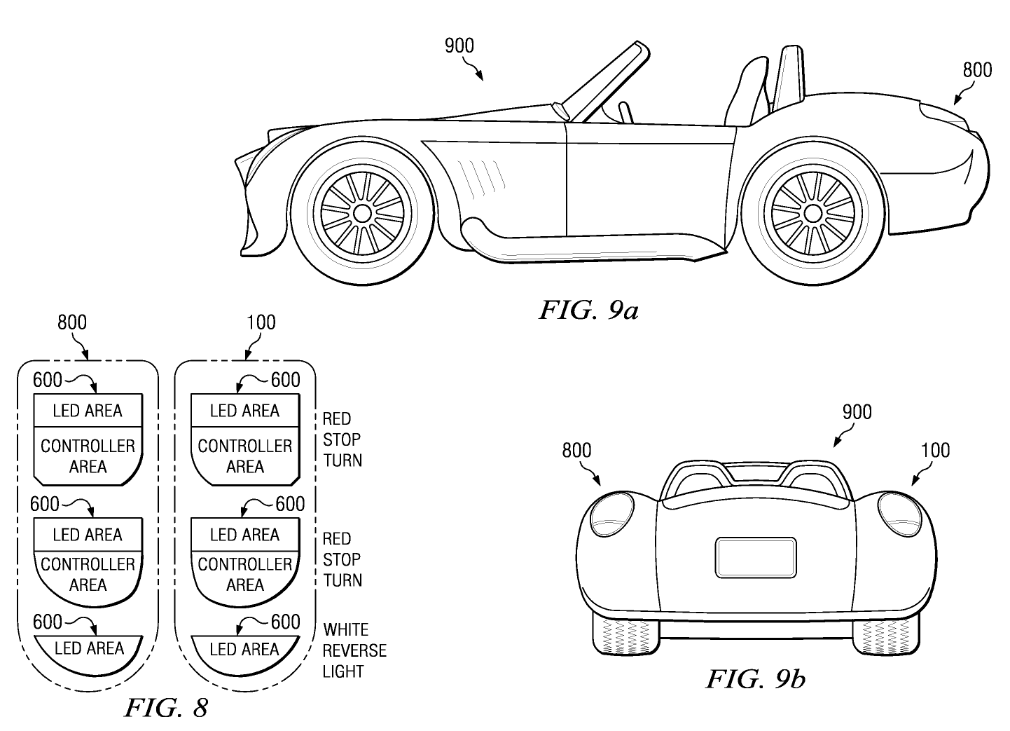

Referring to FIGS. 9a and 9b, one embodiment of a vehicle 900 illustrates the tail light module 100 of FIG. 1 after installation as the back right (i.e., passenger's side) tail light module. A second tail light module, such as the tail light module 800 of FIG. 8, is installed as the back left tail light module. As described above, the configurable indicator array 600, which is positioned behind the cover 102, provides variable lighting depending on its configuration.

It will be appreciated by those skilled in the art having the benefit of this disclosure provides a configurable tail light module. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A tail light module comprising:
a support structure having a cavity formed therein, wherein the cavity contains at least part of a frame spanned by a plurality of cross-members;
a configurable indicator array positioned adjacent to the plurality of cross-members, wherein the configurable indicator array includes a plurality of individually controllable lights; and
at least one controller coupled to the configurable indicator array, wherein the at least one controller is configured to activate and deactivate at least some of the plurality of individually controllable lights to simultaneously form at least two light patterns on the configurable indicator array, wherein the two light patterns are selected from a plurality of possible light patterns.

2. The tail light module of claim 1 further comprising a cover having a reflective translucent portion, wherein the cover is positioned over the opening and the configurable indicator array.

3. The tail light module of claim 1 wherein the individually controllable lights are light emitting diodes (LEDs).

4. The tail light module of claim 3 wherein a wavelength of light emitted by a first one of the LEDs is different than a wavelength of light emitted by a second one of the LEDs in order to provide two colors of light.

5. The tail light module of claim 4 wherein the first one of the LEDs emits red light, the second one of the LEDs emits green light, and a third LED emits blue light.

6. A tail light system comprising:
a support structure configured to be attached to a vehicle, wherein the support structure includes a cavity;
a bezel coupled to the support structure and positioned at least partially within the cavity, the bezel having a frame and a plurality of cross-members coupled to the frame, wherein the cross-members are separated from one another by a space;
a light array positioned at least partially within the cavity, the light array having a plurality of individually controllable lights positioned to emit light through the spaces separating the cross-members; and
at least one controller coupled to the light array, wherein the controller is configured to activate and deactivate first and second portions of the plurality of individually controllable lights to form first and second light patterns, respectively, on the light array, wherein the first and second light patterns can be formed simultaneously.

7. The tail light system of claim 6 further comprising a cover positioned over the cavity, wherein the cover has a convex exterior surface and a concave interior surface, and wherein the cover is constructed of a material designed to permit light to pass therethrough.

8. The tail light system of claim 7 wherein the cross-members are substantially parallel and wherein each cross-member has an upper and lower side joined by front and back edges, wherein the upper sides are substantially planar, and wherein the bezel is positioned within the support structure so that the front edge of each cross-member faces an area to the rear of the vehicle.

9. The tail light system of claim 8 wherein the front edge of each cross-member is curved to substantially match a corresponding curve of the concave interior surface of the cover.

10. The tail light system of claim 6 wherein the at least one controller includes a first controller configured to activate and deactivate the first portion of the plurality of individually controllable lights to form the first light pattern and a second controller configured to activate and deactivate the second portion of the plurality of individually controllable lights to form the second light pattern.

11. The tail light system of claim 6 wherein the first light pattern is restricted to a first area of the light array and the second light pattern is restricted to a second area of the light area that does not overlap with the first area.

12. The tail light system of claim 11 wherein the first portion of the plurality of individually controllable lights emit red light and the second portion of the plurality of individually controllable lights emit yellow light.

13. The tail light system of claim 11 wherein the first and second portions of the plurality of individually controllable lights emit white light and wherein the first portion is positioned behind a red tinted covering material and the second portion is positioned behind a yellow tinted covering material.

14. The tail light system of claim 6 further comprising a computer coupled to the at least one controller, wherein the at least one controller is configured to receive an instruction from the computer and, in response to the instruction, activate the first portion of the plurality of individually controllable lights to form the first light pattern, wherein the instruction does not identify which particular lights of the individually controllable lights are to be activated.

15. The tail light system of claim 6 further comprising a computer coupled to the at least one controller, and wherein the at least one controller is configured to receive an instruction from the computer and, in response to the instruction, activate the first portion of the plurality of individually controllable lights to form the first light pattern, wherein the instruction identifies which particular lights of the individually controllable lights are to be activated.

16. The tail light system of claim 6 further comprising at least one support member coupled to the frame, wherein the at least one controller is fastened to the support member.

17. The tail light system of claim 6 wherein the individually controllable lights are light emitting diodes (LEDs).

18. A tail light module comprising:
a bezel having a frame and a plurality of substantially planar cross-members coupled to the frame, wherein the cross-members are substantially parallel to one another with a space between each cross-member and the adjacent cross-members;
a light emitting diode (LED) array having a plurality of individually controllable LEDs, wherein the LED array is positioned relative to the cross-members so that the plurality of individually controllable LEDs can emit light through the spaces existing between the cross-members; and
a controller coupled to the LED array, wherein the controller is configured to activate and deactivate a first set of the plurality of individually controllable LEDs to form a brake light pattern and a second set of the plurality of individually controllable LEDs to form a turn signal pattern, wherein the brake light and turn signal patterns can be activated simultaneously.

19. The tail light module of claim 18 wherein the LED array is coupled to the bezel by sliding at least a portion of the LED array into a groove present in at least one of the plurality of cross-members.

20. The tail light module of claim 18 wherein the controller is coupled to a support member that forms part of the bezel.
